(19) United States
(12) Patent Application Publication
(10) Pub. No.: US 2011/0077852 A1
(43) Pub. Date: Mar. 31, 2011

(54) User-defined marked locations for use in conjunction with a personal navigation device

(76) Inventors: Mythreyi Ragavan, Auckland (NZ); Takuya Otani, Auckland (NZ)

(21) Appl. No.: 12/566,674

(22) Filed: Sep. 25, 2009

(51) Int. Cl. G01C 21/00; G10L 19/00

(52) U.S. Cl. 701/201; 701/207; 701/213; 704/201

(57) ABSTRACT

A method of creating and storing a marked location in a portable electronic device includes receiving current position information of the portable electronic device, recording description data for a marked location when a user of the portable electronic device is located at the marked location, and storing the description data and position information corresponding to the marked location in a memory.

### BACKGROUND OF THE INVENTION

1. Field of the Invention

The invention relates to a personal navigation device, and more particularly, to personal navigation device that stores user-defined marked locations created by the personal navigation device or another portable electronic device.

2. Description of the Prior Art

Global Positioning System (GPS) based navigation devices are well known and are widely employed as in-car navigation devices. Common functions of a navigation device include providing a map database for generating navigation instructions that are then shown on a display of the navigation device. These navigation devices are often mounted on or in the dashboard of a vehicle using a suction mount or other mounting means.

The term “navigation device” refers to a device that enables a user to navigate to a pre-defined destination. The device may have an internal system for receiving location data, such as a GPS receiver, or may merely be connectable to a receiver that can receive location data. The device may compute a route itself, or communicate with a remote server that computes the route and provides navigation information to the device, or a hybrid device in which the device itself and a remote server both play a role in the route computation process. Portable GPS navigation devices are not permanently integrated into a vehicle but instead are devices that can readily be mounted in or otherwise used inside a vehicle. Generally (but not necessarily), they are fully self-contained—i.e. include an internal GPS antenna, navigation software and maps and can hence plot and display a route to be taken.

When users are traveling somewhere, they often come across a place that they would like to revisit in the future when they have free time. Unfortunately, the users have no convenient way to make a detailed note of the location of this place. The users either have to remember to come back at a later time, or the users have to scramble to find pen and paper, or some other recording means, for making a note to come back and visit this place at a later time. Unfortunately, there are drawbacks to both of these methods. It is not easy to reliably remember details such as this, and it is also difficult to make written notes when driving. Therefore, a need exists for users to conveniently create user-defined marked locations.

### SUMMARY OF THE INVENTION

It is therefore one of the primary objectives of the claimed invention to provide a method of creating and storing marked locations in a personal navigation device or other portable electronic device for allowing users to conveniently mark locations for future reference.

According to an exemplary embodiment of the claimed invention, a method of creating and storing a marked location in a portable electronic device is disclosed. The method includes receiving current position information of the portable electronic device, recording description data for a marked location when a user of the portable electronic device is located at the marked location, and storing the description data and position information corresponding to the marked location in a memory.

According to another exemplary embodiment of the claimed invention, a portable electronic device for creating and storing a marked location is disclosed. The portable electronic device includes a global positioning system (GPS) receiver for receiving current position information of the portable electronic device, a user interface for recording description data for a marked location when a user of the portable electronic device is located at the marked location, and a memory for storing the description data and position information corresponding to the marked location.

It is an advantage that users can quickly and conveniently mark locations that the users wish to revisit in the future. The portable electronic device can precisely mark the position information of the marked location as well as description data provided by the user. The description data can be as short or as detailed as the user wishes to provide, and can be innumerous formats such as a quick voice sound clip. Therefore, the claimed portable electronic device allows users to make notes without causing major distractions to the users.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a personal navigation device according to the present invention.

FIG. 2 shows the personal navigation device connecting to a portable electronic device for importing marked locations or other related data from the portable electronic device.

FIG. 3 is a screen showing properties of a saved user-defined marked location.

FIG. 4 is a map showing superimposed icons representing points of interest and marked locations.

### DETAILED DESCRIPTION

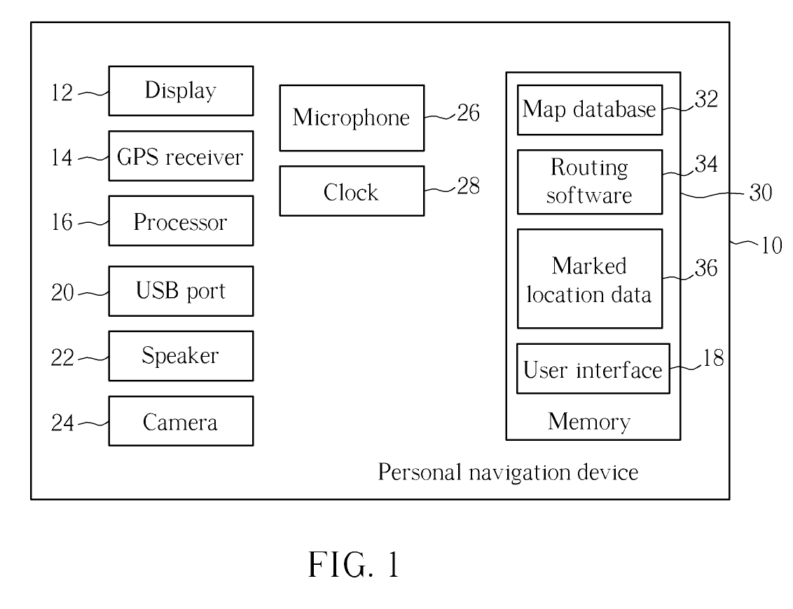

Please refer to FIG. 1. FIG. 1 is a block diagram of a personal navigation device 10 according to the present invention. The personal navigation device 10 contains a display 12 which can be a touch sensitive display, a GPS receiver 14 for receiving the current coordinates of the personal navigation device 10, a processor 16 for controlling operation of the personal navigation device 10, a Universal Serial Bus (USB) port 20 or other similar communication port for allowing data to be exchanged with an external electronic device, a speaker 22, a camera 24 for capturing still or video images, a microphone 26 for recording voice descriptions provided by the user of the personal navigation device 10, a clock 28, and a memory 30. The memory 30 is used to store a map database 32 containing map data and points of interest. The memory 30 also stores routing software 34, marked location data 36 created by the user for storing user-defined marked locations, and program code and data for a user interface 18.

In the present invention, users can create the user-defined marked locations as a way to mark the location for future reference. A hardware button or a soft button can be provided in the user interface 18 for allowing the user to record the marked location. Along with the position coordinates of the marked location provided by the GPS receiver 14, the user can also store a brief description of the area so that the marked data will be more meaningful to the user when the user reviews the marked location in the future. The description data can be in a variety of different formats, including a voice description that the user enters through the microphone 26, text data that the user enters through the user interface 18, image data that the user captures through the camera 24, or other data that the user imports from another electronic device using the USB port 20 or other similar communications port. The clock 28 provides the current time and date, and the time that the marked location was created can also be stored.

When the user is traveling and sees a store, a scenic area, or other place that the user would like to explore later, the user can use the user interface 18 on the personal navigation device 10 to record this area as a marked location. If the user is driving, and has limited time and attention available for recording the marked location, the user can simply press a button and record a voice tag that briefly describes the location. Note that this button can be a soft button provided in the user interface 18 and shown on the touch-sensitive display 12. Alternatively, the button can be a dedicated physical button located on the housing of the personal navigation device 10 that is specifically used for marking a location and recording a description about the location. The user can either press the button again to stop recording the voice description, or the user can release the button if the button was held down during recording. Instead of, or in addition to, creating the voice tag, the user can also create a text tag containing a text description. The camera 24 can also be used for taking a quick snapshot or video clip of the marked location. If the personal navigation device 10 does not contain the camera 24, an image can also be imported at a later time.

After the marked location is recorded, it is stored in the marked location data 36 section of memory 30. The marked location is then added to a list of other marked locations that the user can review at a later time. The user can select one of the marked locations and hear or view the description associated with the marked location. If the user wishes to go to the marked location, the personal navigation device 10 the user can indicate the wish to travel there, and the routing software 34 will provide the user with navigation instructions for reading the marked location.

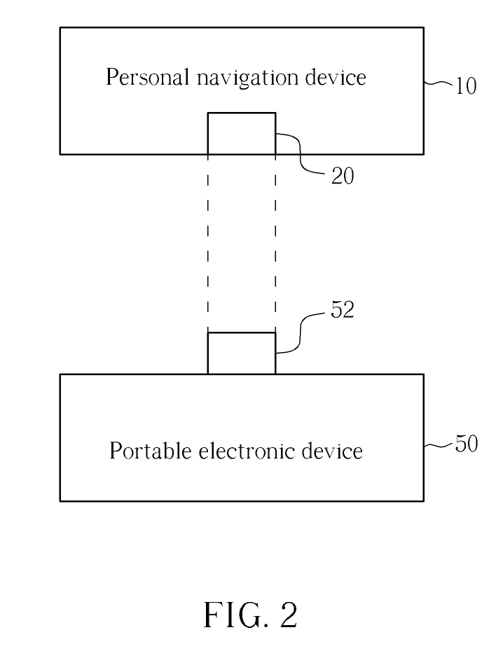

Please refer to FIG. 2. FIG. 2 shows the personal navigation device 10 connecting to a portable electronic device 50 for importing marked locations or other related data from the portable electronic device 50. The portable electronic device 50 can serve numerous functions. In one embodiment, the portable electronic device 50 may be a simplified version of the portable electronic device 50, and may contain a GPS receiver, a microphone, a clock, and optionally a camera for recording marked locations. Users can carry the portable electronic device 50 around with them at times when the users are not able to take the personal navigation device 10. Therefore, the portable electronic device 50 could be used to record the marked locations, and then later a communication interface 52 (such as a USB port) of the portable electronic device 50 could be connected with the USB port 20 or other communication port of the personal navigation device 10 for transferring the marked locations recorded by the portable electronic device 50 to the marked location data 36 section of memory 30 in the personal navigation device 10. Therefore, the personal navigation device 10 itself can be used for creating the marked locations, or the portable electronic device 50 can be used for creating the marked locations and later transferring the marked locations to the personal navigation device 10. Once the marked locations are stored in the personal navigation device 10, the personal navigation device 10 can provide routing instructions to the marked locations as well as show the marked locations as icons on maps.

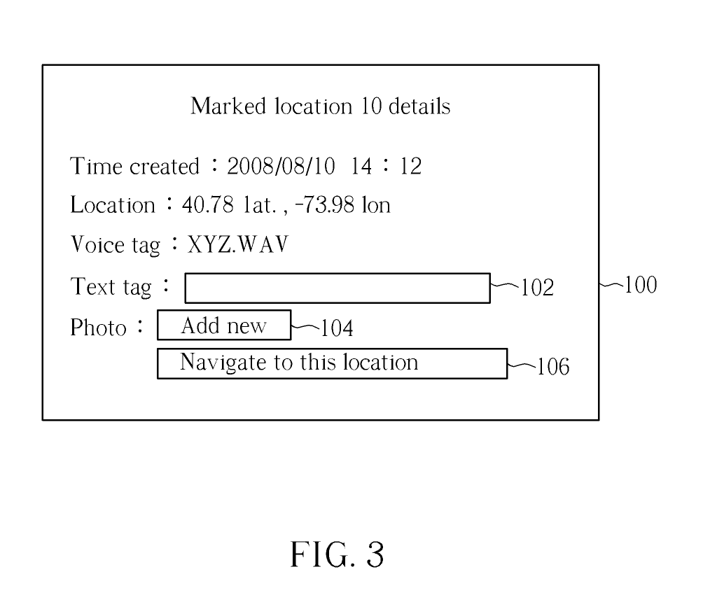

Please refer to FIG. 3. FIG. 3 is a screen 100 showing properties of a saved user-defined marked location. Screen 100 shows the details for marked location number 10, and the stored details include the time and date that the marked location was created, the longitude and latitude position coordinates provided by the GPS receiver 14 and corresponding to the location at which the user recorded the marked location, and a voice tag saved as a sound file “XYZ.WAV”. Of course, other format sound files can also be used instead of the WAV format, such as Moving Picture Experts Group Layer-3 (MP3) format files. In this example, the user has not yet entered a text tag, and text box 102 can be used for entering a text description of the marked location. The text tag can be entered when the marked location is created, or at some later time, such as after the user has gone home and had a chance to review the marked locations that were created that day. If the user wishes to add a photo (or video clip) corresponding to the marked location, the user can press the “Add new” button 104 for adding an image or video file. The image can be captured directly from the camera 24 or can be imported from another electronic device using the USB port 20. The bottom of screen 100 also shows a “Navigate to this location” button 106 which provides an easy way for the user to instruct the personal navigation device 10 to generate navigation instructions to the marked location.

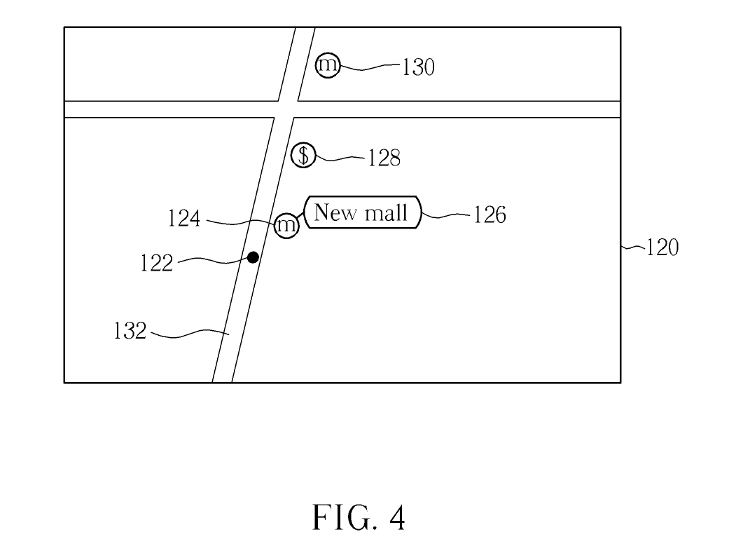

Please refer to FIG. 4. FIG. 4 is a map 120 showing superimposed icons representing points of interest and marked locations. In map 120, point 122 represents the user's current location as the user is driving along road 132. On the map nearby the user's current location 122, icons are used to denote two marked locations 124 and 130 in addition to an icon for a point of interest 128, which represents a bank. The marked locations 124 and 130 were previously created by the user and stored in the marked location data 36 section of memory 30. The user is approaching marked location 124 and wishes to see a description of the marked location 124 to see if it is worth stopping for. The user then taps on the icon representing marked location 124 and a location label 126 appears. In this case, the location label 126 reads “New mall”, which is a text tag that the user previously created for marked location 124. Instead of seeing the location label 126, the user could also see more details of the marked location 124 through other selection means, such as tapping on the location label 126.

Besides using location labels for the user-defined marked locations, the user can also see location labels containing brief descriptions for street names or other points of interest. The location label serves as a brief description of a place without opening up a detailed context window for the selected location, which occupies a significant amount of screen area.

In summary, the present invention utilizes the personal navigation device 10 or other portable electronic device 50 for providing a quick and convenient way for a user to mark locations that the user wishes to revisit in the future. In addition to time and location data for the marked location being stored, the user is also given the chance to add a voice tag, text tag, image tag, or video tag for supplying meaningful description data for the marked location that can be reviewed later. Best of all, the user can review marked locations from a list, select a marked location that the user is interested in, and receive navigation instructions from the personal navigation device 10 to reach the marked location.

Those skilled in the art will readily observe that numerous modifications and alterations of the device and method may be made while retaining the teachings of the invention.

What is claimed is:

1. A method of creating and storing a marked location in a portable electronic device, the method comprising:
receiving current position information of the portable electronic device;
recording description data for a marked location when a user of the portable electronic device is located at the marked location; and
storing the description data and position information corresponding to the marked location in a memory.

2. The method of claim 1, wherein recording description data comprises recording a voice description using a microphone of the portable electronic device and storing the voice description as a sound file.

3. The method of claim 1, wherein recording description data comprises recording a text description and storing the text description as a text file.

4. The method of claim 1, wherein recording description data comprises recording current time and date information.

5. The method of claim 1, wherein recording description data comprises inputting a photo corresponding to the marked location and storing the photo as an image file.

6. The method of claim 1 further comprising displaying a plurality of marked locations stored in the memory.

7. The method of claim 6 further comprising receiving selection of a stored marked location and providing navigation instructions to the selected marked location.

8. The method of claim 1 further comprising displaying an icon corresponding to the marked location on a map shown on the portable electronic device when the portable electronic device is nearby the marked location.

9. The method of claim 8 further comprising displaying a location label corresponding to the marked location when receiving touch input corresponding to a location of the icon shown on a display of the portable electronic device.

10. The method of claim 1, wherein the portable electronic device is a personal navigation device, and the portable electronic device has a communication port for importing one or more marked locations from an external electronic device.

11. A portable electronic device for creating and storing a marked location, comprising:
a global positioning system (GPS) receiver for receiving current position information of the portable electronic device;
a user interface for recording description data for a marked location when a user of the portable electronic device is located at the marked location; and
a memory for storing the description data and position information corresponding to the marked location.

12. The portable electronic device of claim 11 further comprising:
a microphone for recording a voice description from the user, wherein the voice description is stored as a sound file.

13. The portable electronic device of claim 11, wherein the description data is a text description stored in the memory as a text file.

14. The portable electronic device of claim 11, wherein the description data comprises current time and date information.

15. The portable electronic device of claim 11, wherein the description data comprises a photo corresponding to the marked location stored in the memory as an image file.

16. The portable electronic device of claim 11, wherein the user interface displays a plurality of marked locations stored in the memory.

17. The portable electronic device of claim 16, wherein the user interface provides navigation instructions to a selected marked location in response to receiving input indicating selection of one of the stored marked locations.

18. The portable electronic device of claim 11, wherein the user interface displays an icon corresponding to the marked location on a map when the portable electronic device is nearby the marked location.

19. The portable electronic device of claim 18, wherein the user interface displays a location label corresponding to the marked location when receiving touch input corresponding to a location of the icon.

20. The portable electronic device of claim 11, wherein the portable electronic device is a personal navigation device, and the portable electronic device has a communication port for importing one or more marked locations from an external electronic device.
